(19) United States
(12) Patent Application Publication
(10) Pub. No.: US 2014/0352295 A1
(43) Pub. Date: Dec. 4, 2014

(54) INSTALLATION FOR STORING THERMAL ENERGY AND METHOD FOR THE OPERATION THEREOF

(71) Applicant: Siemens Aktiengesekllschaft, Munich (DE)

(72) Inventors: Daniel Reznik, Berlin (DE); Henrik Stiesdal, Odense C (DK)

(73) Assignee: SIEMENS AKTIENGESELLSCHAFT, Munich (DE)

(21) Appl. No.: 14/345,237

(22) PCT Filed: Sep. 26, 2012
(86) PCT No.: PCT/EP2012/068902

§ 371 Date: Mar. 15, 2014

(30) Foreign Application Priority Data
Sep. 29, 2011 (EP) 11183270.5

(51) Int. Cl. F03B 17/00

(52) U.S. Cl. CPC F03B 17/005
USPC 60/530

(57) ABSTRACT

An installation for storing thermal energy is provided, comprising a heat accumulator and a cold accumulator. A method for charging and discharging said thermal accumulators is also provided. Using the installation, excess electrical energy can be utilized for converting mechanical energy from a compressor and a turbine into thermal energy, which is available in the heat accumulator and the cold accumulator for a subsequent generation of electrical energy. A temporary heat store is discharged during the charging of the heat accumulator and the cold accumulator, preheating the working gas for the compressor. When the heat accumulator and the cold accumulator are discharged via the turbine and the compressor for the purpose of generating electrical energy, the temporary store can be recharged so that the heat stored therein can be made available for a subsequent charging process of the heat accumulator and the cold accumulator.

### CROSS REFERENCE TO RELATED APPLICATIONS

This application is the US National Stage of International Application No. PCT/EP2012/068902 filed Sep. 26, 2012, and claims the benefit thereof. The International Application claims the benefit of European Application No. EP11183270 filed Sep. 29, 2011. All of the applications are incorporated by reference herein in their entirety.

### FIELD OF INVENTION

The invention relates to an installation for storing thermal energy, having a circuit for a working gas. There, in the circuit the following units are connected to one another in the order indicated by a line for the working gas: a first thermal fluid energy machine, a heat accumulator, a second thermal fluid energy machine and a cold accumulator.

In the throughflow direction of the working gas, as seen from the heat accumulator to the cold accumulator, the first thermal fluid energy machine is connected as a work machine and the second thermal fluid energy machine is connected as a power machine.

The invention further relates to two methods for operating this installation. In one method for storing thermal energy, the circuit is passed through in the direction from the heat accumulator to the cold accumulator, which corresponds to the abovementioned order of the modular units. According to a further method, to which the invention also relates, stored thermal energy from the installation can also be converted, e.g. into mechanical energy. In this case, the units are passed through in reverse order, in other words the throughflow direction of the working gas is reversed. The gas then passes first through the cold accumulator and then the heat accumulator, wherein in this case the first thermal fluid energy machine is operated as a power machine and the second thermal fluid energy machine is operated as a work machine.

### BACKGROUND OF INVENTION

The terms power machine and work machine are used in the scope of this application such that a work machine takes up mechanical work in order to fulfill its purpose. A thermal fluid energy machine which is used as a work machine is thus used as a compressor. In contrast, a power machine provides work, wherein a thermal fluid energy machine for providing the work converts the thermal energy available in the working gas. In this case, the thermal fluid energy machine is therefore operated as a motor.

The term “thermal fluid energy machine” is an umbrella term for machines which can extract thermal energy from, or supply thermal energy to, a working fluid, in the context of this application a working gas. Thermal energy is to be understood both as heat energy and cold energy. Thermal fluid energy machines can for example be embodied as piston machines. Preferably, hydrodynamic thermal fluid energy machines can also be used, the rotors of which permit a continuous flow of the working gas. Axial turbines and compressors are preferably employed.

The principle indicated above is for example described according to US 2010/0257862 A1. Here, piston machines are employed in order to carry out the method described above. It is in addition known, according to U.S. Pat. No. 5,436,508, that, by means of the installations for storing thermal energy mentioned above, excess capacities in the exploitation of wind energy can also be stored in the interim for the purpose of producing electrical current, such that these can be recalled if required.

### SUMMARY OF INVENTION

An object of the invention includes specifying an installation for storing thermal energy of the type indicated above and/or methods for converting thermal energy (for example converting mechanical energy into thermal energy with subsequent storage or converting the stored thermal energy into mechanical energy), by means of which a high degree of efficiency can be achieved while at the same time ensuring justifiable expenditure on the modular units used.

This object is achieved according to aspects of the invention by the installation mentioned above in that a low-temperature heat accumulator is in addition provided in the circuit, upstream of the first fluid energy machine. This heat accumulator is designated as a low-temperature heat accumulator because the temperature level achieved by storing the heat is, in principle, below the temperature level of the heat accumulator. The heat accumulator could thus, in comparison with the low-temperature heat accumulator, also be designated in the context of the invention as a high-temperature heat accumulator. Furthermore, heat is defined in relation to the ambient temperature of the installation. Anything above the ambient temperature is heat, whereas anything below the ambient temperature is cold. It is thus also clear that the temperature level of the cold accumulator is below the ambient temperature.

The use of the low-temperature heat accumulator has the following advantages. When the installation is used to store the thermal energy, the flow passes through the low-temperature heat accumulator before the first fluid energy machine, working in this case as a work machine (compressor). The working gas is thus already heated above the ambient temperature. This has the advantage that the work machine has to take up less power in order to achieve the required temperature of the working gas. Specifically, the heat accumulator should be heated to above 500° C., which can advantageously be effected subsequent to the preheating of the working gas also with technically available thermodynamic compressors, which permit compression of the working gas to 15 bar. Advantageously, it is thus possible to use components for the modular units of the installation which are available on the market without costly modifications.

The working gas can optionally be guided in a closed circuit or an open circuit. An open circuit always uses the ambient air as the working gas. This is drawn in from the surroundings and also released into this again at the end of the process, such that the surroundings close the open circuit. A closed circuit also allows a working gas other than ambient air to be used. This working gas is guided in the closed circuit. Since expansion in the surroundings while at the same time establishing the ambient pressure and ambient temperature do not occur, the working gas must in the case of a closed circuit be guided through a heat exchanger which allows the working gas to give off or take up heat to or from the surroundings.

It is provided according to one advantageous embodiment of the invention that the circuit is designed as an open circuit and the second thermal fluid energy machine is composed of two stages, wherein a water separator for the working gas is provided between the stages. This takes account of the fact that humidity is contained in the ambient air. Expanding the working gas in a single stage can result in the humidity freezing on account of the intense cooling of the working gas, for example to −114° C., and thus damaging the thermal fluid energy machine. In particular, turbine blades can be permanently damaged by icing. However, by expanding the working gas in two stages it is possible to separate off condensed water in a water separator downstream of the first stage, for example at 5° C., such that, upon further cooling in the second turbine stage, the working gas is already dehumidified and formation of ice can be prevented or at least reduced. Advantageously, the risk of damage to the second fluid energy machine is thus reduced.

If a closed circuit is used and, as already described, a heat exchanger is integrated into the circuit, it is not necessary to use a water separator and a two-stage second thermal fluid energy machine. In this case, dehumidified ambient air can also be used as the working gas, for example, and is prevented from taking up moisture by the fact that the circuit is closed. However, other working gases may also be used.

One particular configuration of the installation according to the invention provides that a third thermal fluid energy machine is connected in the circuit in parallel with the first thermal fluid energy machine, and/or a fourth thermal fluid energy machine is connected in the circuit in parallel with the second thermal fluid energy machine. In this case, a valve mechanism is in each case provided between the first and third and/or between the second and fourth thermal fluid energy machines. By switching the valve mechanism, it is now advantageously possible, depending on the throughflow direction of the working gas, to select either one or the other fluid energy machine. This has the advantage that the respective fluid energy machine being used can be optimized to the operating state to be connected. Since when using only two fluid energy machines both must be used as both work machine and power machine, depending on the throughflow direction, if additional fluid energy machines are not provided a design compromise is the only option. However, since the greatest possible efficiency is desired in both the thermal charging operation and the thermal discharging operation, connecting fluid energy machines in parallel makes it possible to carry out both the method for storing the thermal energy and the method for converting the thermal energy with optimum efficiency.

The object is moreover achieved by a method for storing thermal energy as mentioned above, in that the working gas flows through a low-temperature heat accumulator, upstream of the first fluid energy machine. This means that the working gas, heated by the low-temperature heat accumulator, is fed into the first fluid energy machine. The aforementioned advantages are thus achieved. Advantageously, the working gas can be heated in the low-temperature heat accumulator to a temperature between 60° C. and 100° C., particularly advantageously to a temperature of 80° C. As already mentioned, according to a further configuration of the invention, the working gas can then be compressed to at most 15 bar, whereby the temperature of the working gas can reach 550° C.

In the same way, the object is achieved by a method for converting thermal energy as mentioned above, in that (when the flow direction of the working gas is reversed) the working gas flows through a low-temperature heat accumulator, downstream of the first fluid energy machine. In this case, with reference to the installation used, it is of course the same low-temperature heat accumulator which is used in the abovementioned method for storing the thermal energy. This has namely the advantage that, after a process for converting the thermal energy, the low-temperature heat accumulator is recharged while the heat accumulator and the cold accumulator are discharged. If the process is again reversed in a method for storing thermal energy, the energy stored in the interim in the low-temperature heat accumulator is now available for preheating the working gas. Only when commissioning the installation, when running the method for storing thermal energy for the first time, does the heat need to be made available by another means, since this heat could not yet have been made available beforehand by a method for converting the thermal energy. If this energy, which is otherwise stored in the low-temperature heat accumulator, is not made available, the method for storing thermal energy still works, albeit not with the desired efficiency. However, if the process is reversed multiple times, the required intended state of the installation is also achieved without the use of external energy.

Advantageously, the working gas can be heated in the low-temperature heat accumulator to a temperature between 100° C. and 160° C. Of particular advantage is heating to 130° C. It is of further advantage in this context if the working gas is compressed by the second thermal fluid energy machine to at most 10 bar. This too is an expedient technical compromise in weighing up cost and benefit.

### BRIEF DESCRIPTION OF THE DRAWINGS

Further details of the invention will be described below with reference to the drawing. Identical or corresponding drawing elements are here in each case provided with the same reference signs and are only explained repeatedly where there are differences between the individual figures, in which:

FIG. 1 shows an exemplary embodiment of the installation according to the invention as a circuit diagram and

FIGS. 2 and 3 show exemplary embodiments of the method according to the invention by means of further circuit diagrams.

### DETAILED DESCRIPTION OF INVENTION

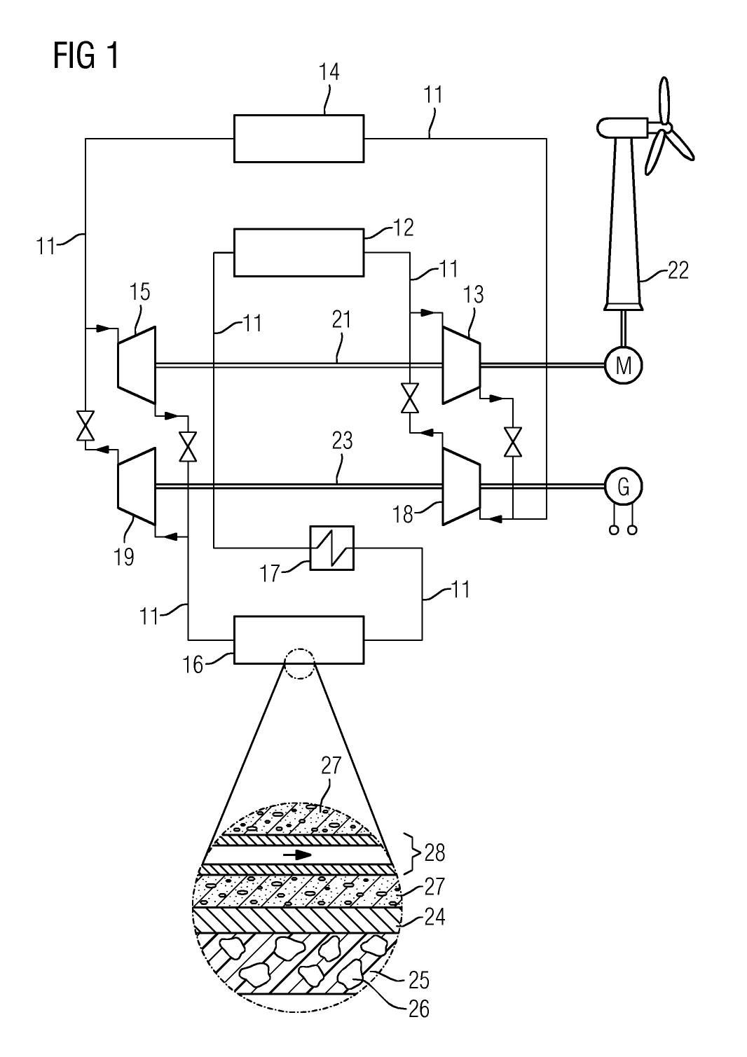

An installation for storing thermal energy according to FIG. 1 has a line 11 in which a plurality of units are connected to one another such that a working gas can flow through them. The working gas flows through a low-temperature heat accumulator 12 and then through a first thermal fluid energy machine 13, which is designed as a hydrodynamic compressor. Furthermore, the line then leads to a heat accumulator 14. This is connected to a second thermal fluid energy machine 15, which is embodied as a hydrodynamic turbine. From the turbine, the line 11 leads to a cold accumulator 16. The cold accumulator 16 is connected to the low-temperature heat accumulator 12 via the line 11, wherein in this line section there is also provided a heat exchanger 17 in which the working gas can give off heat to or take in heat from the surroundings (depending on the mode of operation).

In FIG. 1, provision is thus made of a closed circuit for the working gas. However, it can similarly be envisaged that, in a manner not represented, the line section between the cold accumulator 16 and the low-temperature heat accumulator 12, together with the heat exchanger 17, can be dispensed with. In this case, the circuit would be closed by the surroundings, wherein the working gas, which in this case includes ambient air, would be drawn in at the low-temperature heat accumulator 12 and again expelled to the surroundings downstream of the cold accumulator 16.

Furthermore, in FIG. 1 provision is made of a third thermal fluid energy machine 18 in the form of a hydrodynamic turbine and a fourth thermal fluid energy machine 19 in the form of a hydrodynamic compressor. It is further of note that the first hydrodynamic fluid energy machine 13 in the line 11 is connected in parallel with the third hydrodynamic fluid energy machine 18, and the second fluid energy machine 15 in the line 11 is connected in parallel with the fourth fluid energy machine 19. Valve mechanisms 20 ensure, by opening and closing, that in each case there is a flow through only the first and second fluid energy machines or only the third and fourth fluid energy machines. The first and second fluid energy machines 13 and 15 are mechanically coupled to each other via a first shaft 21 and are driven by an electric motor M, which is powered by a wind power plant 22 as long as there is no demand in the grid for the electrical energy generated. During this operating state, the heat accumulator 14 and the cold accumulator 16 are charged, as will be explained in more detail below. If the demand for electrical energy is greater than the quantity of electrical energy actually produced, the electricity produced by the wind power plant 22 is fed directly into the grid. In addition, in another operating state, the installation supports the production of electricity in that the heat accumulator 14 and the cold accumulator 16 are discharged and a generator G is driven by the fluid energy machines 18 and 19 using a second shaft 23. To that end, the second shaft 23 is mechanically coupled to the third fluid energy machine 18 and the fourth fluid energy machine 19.

The construction of the low-temperature heat accumulator 12, of the heat accumulator 14 and of the cold accumulator 16 in the case of the installation according to FIG. 1 is in each case identical and is explained in more detail by means of an enlarged detail with reference to the cold accumulator 16. There is provided a container, the wall 24 of which is provided with an insulating material 25 which has large pores 26. Concrete 27, which acts as a heat accumulator or as a cold accumulator, is provided on the inside of the container. Pipes 28 running in parallel are laid inside the concrete 27, through which pipes the working gas flows and thereby gives off or takes up heat (depending on the mode of operation and type of accumulator).

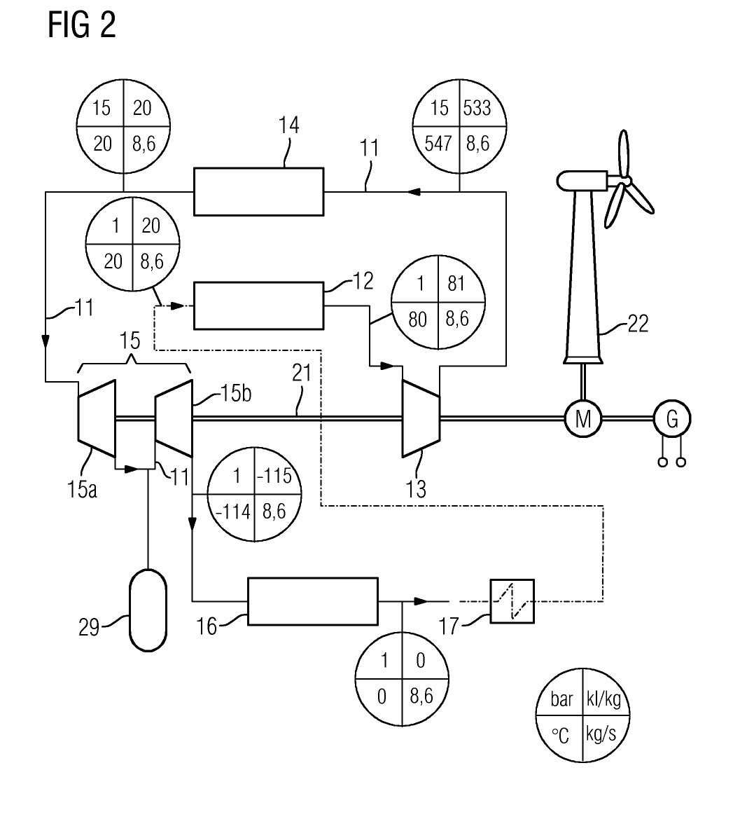

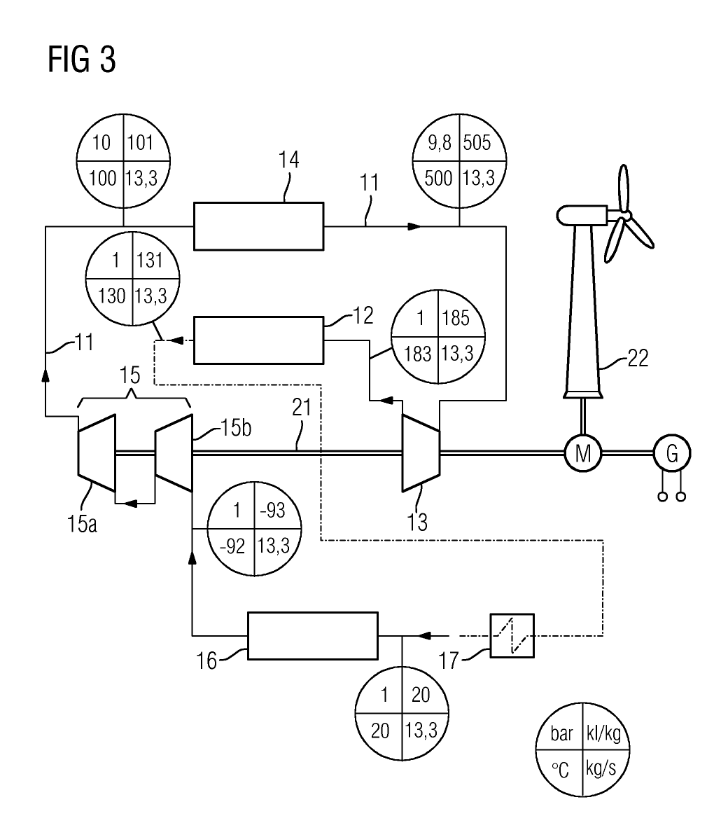

The thermal charging and discharging process is to be explained in more detail by means of the installation according to FIGS. 2 and 3. The charging process, which functions according to the principle of a heat pump, is first represented in FIG. 2. In contrast to FIG. 1, FIGS. 2 and 3 represent an open circuit which, however, as indicated by the dash-dotted line, could be closed by using the optionally provided heat exchanger 17. The conditions in the working gas, which in the exemplary embodiment of FIGS. 2 and 3 includes air, are in each case represented by circles on the lines. The upper left quadrant shows pressure in bar, the upper right shows enthalpy in kJ/kg, the lower left shows temperature in ° C. and the lower right quadrant shows mass flow rate in kg/s. The flow direction of the gas is indicated by arrows in the line 11.

In the model calculation, the working gas arrives in the (previously charged) low-temperature heat accumulator at one bar and 20° C., and leaves it at a temperature of 80° C. Compression by the first fluid energy machine 13, working as a compressor, results in an increase in pressure to 15 bar and, as a consequence, also in an increase in temperature to 547° C. This calculation is based on the following formula:

T₂=T₁+(T₂ₛ−T₁)/η_{c}; T₂ₛ=T₁π^{(K-1)/K}, where

T₂ is the temperature at the compressor outlet,

T₁ is the temperature at the compressor inlet,

η_{c} is the isentropic efficiency of the compressor,

π is the pressure ratio (in this case 15:1) and

K is the compressibility, which for air is 1.4.

The isentropic efficiency π_{c} can be assumed to be 0.85 for a compressor.

The heated working gas now runs through the heat accumulator 14, where the majority of the available thermal energy is stored. During the storage, the working gas cools to 20° C., while the pressure (disregarding flow-induced pressure losses) remains at 15 bar. The working gas is then expanded in two series-connected stages 15a, 15b of a second fluid energy machine, such that it arrives at a pressure of one bar. In so doing, the working gas is cooled to 5° C. after the first stage and to −114° C. after the second stage. This calculation is also based on the formula indicated above.

A water separator 29 is also provided in that part of the line 11 which connects the two stages of the second fluid energy machine 15a, 15b in the form of a high-pressure turbine and a low-pressure turbine. This allows the air to be dried after a first expansion, such that, in the second stage 15b of the second fluid energy machine 15, the humidity contained in this air does not lead to icing of the turbine blades.

Further on, the expanded and thus cooled working gas removes heat from the cold accumulator 16 and is thus heated to 0° C. In this manner, cold energy is stored in the cold accumulator 16, which cold energy can be used in subsequent energy recovery. If one compares the temperature of the working gas at the outlet of the cold accumulator 16 and at the inlet of the low-temperature heat accumulator 12, it is obvious why, in the case of a closed circuit, the heat exchanger 17 must be made available. In this case, the working gas can be reheated to an ambient temperature of 20° C., in which heat is removed from the surroundings and is made available for the process. Such a measure can of course be dispensed with if the working gas is drawn directly from the surroundings, as this is already at ambient temperature.

FIG. 3 illustrates the discharging cycle of the heat accumulator 14 and of the cold accumulator 16, wherein electrical energy is produced at the generator G. In contrast to FIG. 1, in FIG. 3 the first fluid energy machine 13 and the second (two-stage) fluid energy machine 15 are used both in the charging and in the discharging cycle. This does not impair the functional principle of the installation but is at the cost of lower efficiency. The greater cost of investment when using, in addition, a third and a fourth fluid energy machine must therefore be weighed up against the increase in efficiency achieved by the fact that, by using four fluid energy machines, each of these can be optimized to the respective operating state. The alternative of a closed circuit is again represented by the dash-dotted line. The water separator 29 is not represented in the representation of FIG. 3 as it is not used.

The working gas is guided through the cold accumulator 16. There it is cooled from 20° C. to −92° C. This measure serves to reduce the power required for operating the second fluid energy machine working as a compressor. The power requirement is reduced by a factor corresponding to the temperature difference in Kelvin, that is to say 293K/181K=1.62. In the example, the compressor compresses the working gas to 10 bar. In so doing, the temperature rises to 100° C. Another technically feasible option would be a compression of up to 15 bar. The compressed working gas passes through the heat accumulator 14 and is thereby heated to 500° C., wherein the pressure decreases slightly to 9.8 bar. The working gas is then expanded by the first fluid energy machine, which thus works as a turbine in this operating state. There follows an expansion to 1 bar, wherein at the outlet of the first fluid energy machine the working gas is still at a temperature of 183° C.

In order to also be able to use this residual heat, the working gas is then guided through the low-temperature heat accumulator and is thus cooled further to 130° C. This heat must be stored such that it can serve in a subsequent charging process of the heat accumulator 14 and of the cold accumulator 16 for preheating the working gas to 80° C. (as already described above). The low-temperature heat accumulator thus works as an intermediate accumulator and is always charged only when the two other accumulators, i.e. the heat accumulator 14 and the cold accumulator 16, are discharged, and conversely.

1. An installation for storing thermal energy, comprising
a circuit for a working gas, wherein in the circuit the following units are connected to one another in the order indicated by a line for the working gas:
a first thermal fluid energy machine,
a heat accumulator,
a second thermal fluid energy machine and
a cold accumulator,
wherein, in the throughflow direction of the working gas, as seen from the heat accumulator to the cold accumulator, the first thermal fluid energy machine is connected as a work machine and the second thermal fluid energy machine is connected as a power machine,
wherein a low-temperature heat accumulator is provided in the circuit, upstream of the first fluid energy machine, wherein
the circuit is embodied as a closed circuit and a heat exchanger is arranged in the circuit, between the cold accumulator and the low-temperature heat accumulator, or
the circuit is open between the cold accumulator and the low-temperature heat accumulator.

2. The installation as claimed in claim 1, wherein
the circuit is designed as an open circuit and the second thermal fluid energy machine is composed of two stages, wherein a water separator for the working gas is provided between the stages.

3. The installation as claimed in claim 1, wherein
a third thermal fluid energy machine is connected in the circuit in parallel with the first thermal fluid energy machine, and/or a fourth thermal fluid energy machine is connected in the circuit in parallel with the second thermal fluid energy machine,
wherein a valve mechanism is in each case provided between the first and third and/or between the second and fourth thermal fluid energy machines.

4. A method for storing thermal energy, in which a working gas passes through a circuit, wherein in the circuit the flow passes through the following units in the order indicated:
a first thermal fluid energy machine,
a heat accumulator,
a second thermal fluid energy machine and
a cold accumulator,
wherein the first thermal fluid energy machine is operated as a work machine and the second thermal fluid energy machine is operated as a power machine,
wherein the working gas flows through a low-temperature heat accumulator, upstream of the first fluid energy machine.

5. The method as claimed in claim 4, wherein
the working gas is heated in the low-temperature heat accumulator to a temperature between 60° C. and 100° C.

6. The method as claimed in claim 4, wherein
the working gas is compressed by the first thermal fluid energy machine to at most 20 bar.

7. A method for converting thermal energy, in which a working gas passes through a circuit, wherein in the circuit the flow passes through the following units in the order indicated:
a cold accumulator,
a second thermal fluid energy machine,
a heat accumulator and
a first thermal fluid energy machine,
wherein the first thermal fluid energy machine is operated as a power machine and the second thermal fluid energy machine is operated as a work machine,
wherein the working gas flows through a low-temperature heat accumulator, downstream of the first fluid energy machine.

8. The method as claimed in claim 7, wherein
the working gas is cooled in the low-temperature accumulator to a temperature between 100° C. and 160° C.

9. The method as claimed in claim 7, wherein
the working gas is compressed by the second thermal fluid energy machine to at most 15 bar.

10. The method as claimed in claim 4, wherein
the working gas is heated in the low-temperature heat accumulator to a temperature of about 80° C.

11. The method as claimed in claim 4, wherein
the working gas is compressed by the first thermal fluid energy machine to at most 15 bar.

12. The method as claimed in claim 7, wherein
the working gas is cooled in the low-temperature accumulator to a temperature of about 130° C.

13. The method as claimed in claim 7, wherein
the working gas is compressed by the second thermal fluid energy machine to at most 10 bar.
